(19) United States
(12) Patent Application Publication
(10) Pub. No.: US 2004/0100087 A1
(43) Pub. Date: May 27, 2004

(54) Promotional card and method of advertising including vendor discounts

(76) Inventor: Clifford P. Ching, Westminster, CO (US)

Correspondence Address: John E. Reilly, 1554 Emerson Street, Denver, CO, 80218, US

(21) Appl. No.: 10/305,337

(22) Filed: Nov. 26, 2002

(51) Int. Cl. G09F 1/00

(52) U.S. Cl. 283/56

(57) ABSTRACT

A method and device bearing information of a promotional nature to encourage repeated use of a promotional card by a customer in order to obtain promotional discounts offered by a vendor. The preferred form of the device comprises a wallet-sized card containing business information of a sponsor, promoter information, as well as a space to record transactions redeemed with the vendor by the cardholder. The method comprises the steps of imprinting information of sponsors and promoters on a promotional card, imprinting a transaction grid on the opposite face of the card and circulating the card to customers of the sponsor together with information identifying vendors offering discounts. An alternate form of the device includes an actual business card of the sponsor as the front face which may be laminated and bonded to a card containing promoter information as well as a transaction grid.

### BACKGROUND AND FIELD OF INVENTION

The present invention generally relates to advertising methods and devices; and more particularly relates to a novel and improved method and device for advertising promotional discounts via a promotional card which allows the cardholder to obtain discounts from selected vendors.

A variety of methods have been developed to promote vendors through the use of discount coupons or discount books. Effective sales are often achieved through a combination of advertising and promotional discounts. The challenge faced by many businesses is the ability to direct consumer attention to a particular business over a period of time so that when the consumer is in need of services, the particular business is recalled by the consumer.

Typically, businesses will provide business cards for its members to pass out to the general public as a form of advertising the particular business. Due to the fact that business cards are typically circulated in large numbers, potential customers often will discard them or place them in a location and forget about them. One key to advertising is to have the ability to place a name or logo in front of a customer numerous times to increase consumer attention to source and identity.

This invention creates an interface between business advertising and vendor advertising. The customer receives and retains the promotional card of the sponsor due to the fact that the holder of the card is entitled to discounts or promotions from selected vendors. For example, these vendors may be shown on a website, on the back of the business card, or published in a newspaper. This results in a two-fold advertising plan enabling both the sponsors and vendors to advertise and offer promotional discounts under one plan. Heretofore, there has not been available an effective method and means for advertising which incorporates both a sponsor and vendor on a single card.

### SUMMARY OF THE INVENTION

It is an object of the present invention to provide a novel and improved method and advertising device for sponsors which combines advertising of a sponsor and vendor on a single promotional card.

Another object of the present invention is to provide a novel method and means to provide discounts or promotions to promotional cardholders offered by preselected vendors.

Another object of the present invention is to provide a novel method and means to promote the products of preselected vendors.

An advantage of the present invention is that customers are repeatedly exposed to sponsors' names contained on the promotional card, thereby increasing consumer attention to sponsor source and identity.

Another advantage of the present invention is to discourage discarding of business cards by potential customers due to their utility for discounts.

Another advantage and feature of the present invention is a discount plan incorporated into a promotional card which is simply placed in a wallet or purse with no need for bulky discount or coupon books.

A final advantage and feature of the present invention is a listing of vendors on a website in such a way as to allow for constant updating as well as reducing printing costs.

In accordance with the present invention, a promotional device is provided whereby identifying information of a sponsor is placed on the front face of a promotional card and a transaction grid is placed on the opposite side of the business or promotional card. The method of advertising comprises placing identifying information of a sponsor on the front face of the promotional card and imprinting a transaction grid on the opposite face.

Information concerning a promoter may also be placed on the front face of the promotional card and information governing use of the card may also be placed on the opposite side of the promotional card.

The promoter is responsible for identifying sponsors desirous of advertising as well as vendors also interested in advertising their products or services and offering discounts. The names and all identifying information of the vendor as well as any advertising may be placed on the back of the promotional card, published in a newspaper, distributed on a separate sheet of paper to be given to cardholders, or placed on a website so that business cardholders may access the website to obtain information concerning vendors participating in the plan. Preferably, cardholders will present the promotional card when entering the establishment of the preselected vendors in order to obtain the discounts provided in the plan. Cardholders are repeatedly exposed to the business name of the sponsor as well as vendors' advertising, encouraging promotion of both sponsors and vendors.

There have been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a front view of a promotional card implementing a preferred advertising method in accordance with the present invention;

FIG. 2 is a rear view of the promotional card of FIG. 1;

FIG. 3 is a front view of an alternative embodiment of a promotional card;

FIG. 4 is a rear view of an alternative embodiment of the promotional card of FIG. 3;

FIG. 5 is a flow chart illustrating the relationship between the promoter, sponsor and cardholder in the advertising method and device of the present invention;

FIG. 6 is a flow chart illustrating the relationship between the promoter, vendor and cardholder in the advertising method of the present invention; and

FIG. 7 is a flow chart illustrating the relationship between all entities involved in the advertising method and device of the present invention.

### DETAILED DESCRIPTION OF PREFERRED EMBODIMENT

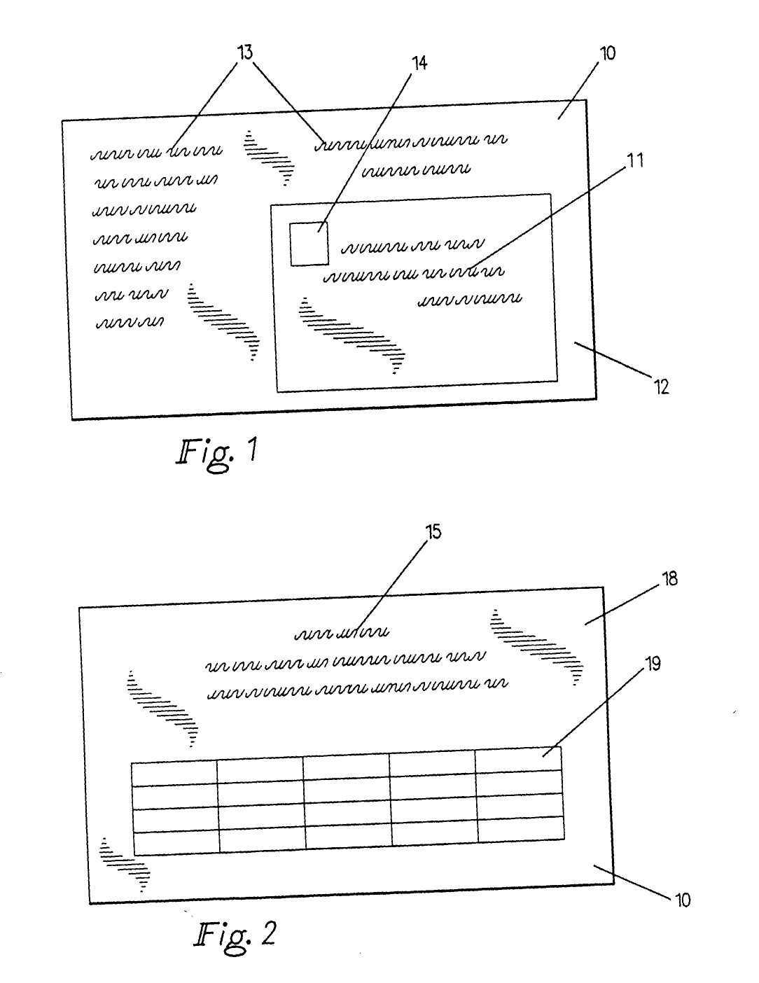

Referring now to the drawings, FIGS. 1 and 2 illustrate a device for advertising promotional materials.

FIG. 1 shows a preferred embodiment of a promotional or business card 10 having a display of a sponsor's business information 11 on the face or front 12 of the card. The information may consist of the sponsor's name, address and identification of sponsor's business or service as well as a small photograph 14 of the sponsor. Generally, these types of businesses will include realtors, stockbrokers and any other type of group that offers products or services. The business information 11 is displayed to a customer at the time the sponsor places the invention 10 in circulation.

Information 13 concerning a promoter may also be placed on the face of the invention 10, as demonstrated in FIG. 1. The promoter is responsible for identifying potential sponsors who desire to purchase promotional cards and imprinting the promotional cards with the sponsor's identifying information. The promoter also selects vendors to participate in the plan and publishes information concerning the list of vendors as well as promotional discounts offered. Promoter information may include the name of the promoter as well as any restrictions on use of the discounts or promotions offered by preselected vendors. The information contained on the invention is preferably embossed on standard business card stock paper. FIG. 2 illustrates the reverse or opposite side 18 of the promotional card 10 which contains the information 15 governing use of the promotional discounts. These include an expiration date of the card as well as any restrictions as to use of the card, such as, locations or States where the discount is honored.

There is also present a discount or transaction grid 19 within which a vendor or merchandiser that provides the discount may place relevant information. The grid 19 is available for use by the vendor preferably to note or record discounts previously redeemed by the cardholder. In this way, if a vendor desires to offer a one-time discount, the use of the discount can be noted on the back of the card thereby preventing the cardholder from obtaining further discounts from the same vendor. The grid 19 may also be used for other purposes, such as, recording a list of vendors honoring the promotional card, listing the website address containing a list of vendors and other similar types of use.

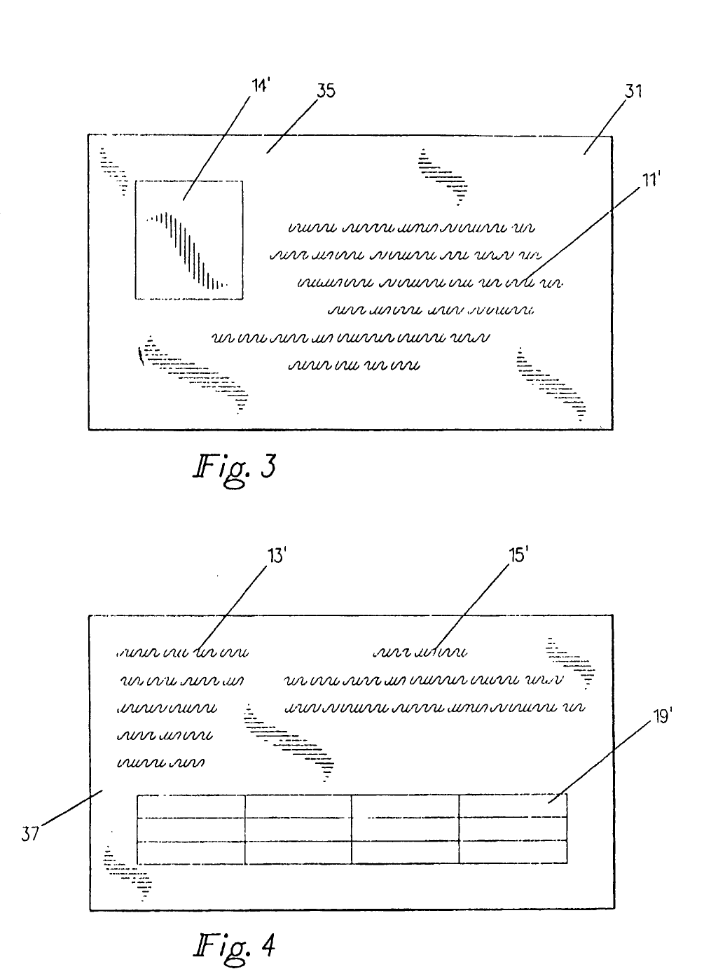

FIGS. 3 and 4 show an alternative embodiment of a promotional card 31 displaying an actual business card of the sponsor containing sponsor information 11′ on a front face 35 of the card. The information 13′ concerning the promoter, information 15′ governing use of the promotional discounts, as well as the discount or transaction grid 19′ are located on the reverse or opposite side 37 of the promotional card 31. The promotional card 31 is then laminated with a single side lamination process, resulting in a protective plastic coating bonded to the front face 35 of the card. The opposite or reverse side 37 is a card of the same size as the front face 35 is bonded to the reverse side of sponsor's business card 31, is not covered with a protective coating, and therefore may be written upon.

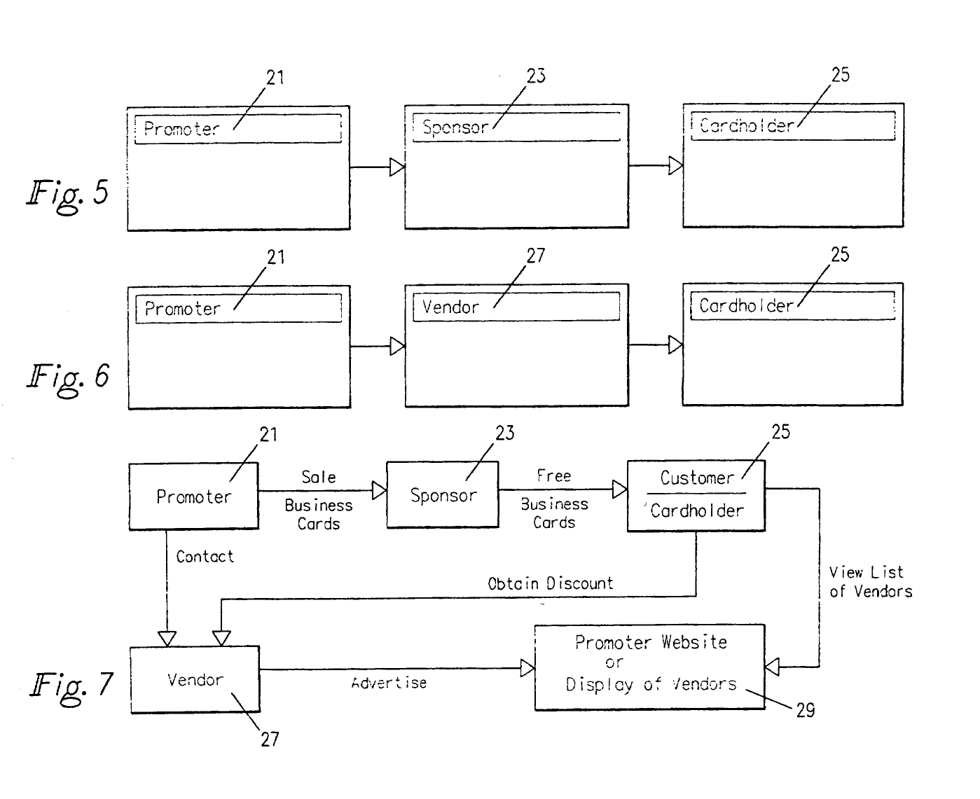

FIG. 5 illustrates the relationship between the promoter 21, sponsor 23 and cardholder 25. The promoter 21 will enlist or procure sponsors 23 interested in purchasing promotional cards. Those sponsors 23 will purchase a predetermined number of promotional cards 10 from the promoter 21. Pursuant to an agreement, the promoter 21 will place the advertising information 11 of the sponsor 23 on the face 12 of the card as in FIG. 1. The sponsor 23 then has the option of distributing the promotional cards 10, usually without charge, to potential customers 25. These cards 10 are preferably dimensioned so as to fit in a wallet and are of standard business card size or may be slightly larger than standard business card size. The cards 10 may also be a bi-fold or multi-fold cards, allowing for additional information to be placed on the cards. The customers 25 are then cardholders entitled to present the card to preselected vendors 27 to obtain promotional discounts.

In the alternative embodiment as shown in FIG. 3, the sponsor provides business cards to the promoter, who then mounts and laminates them to a card containing promoter information as well as the discount grid as in FIG. 4. The promoter provides these cards to the sponsor for distributing to potential customers.

FIG. 6 illustrates the relationship between the promoter 21, vendor 27 and cardholder 25. The promoter 21 will identify vendors based on the products and services offered and will offer to display a list of vendors or place advertisements, including the identifying information of the vendor, on a website developed and updated by the promoter 21 or similar type of published list, which would be available to the cardholder 25. See FIG. 7. The cardholder 25 may access the promoter website 29 to determine discounts available by vendors or a similar type of list created by the promoter. The cardholder 25 may then go to the vendor's establishment, present the promotional card 10 as proof of entitlement to the discount or promotion, and receive the predetermined discount.

FIG. 7 illustrates the interrelationship between FIGS. 5 and 6. The repetitive nature of advertising exposure occurs through transfer of the card 10 to the cardholder 25 and repeated use of the card by the cardholder. The cardholder 25 is exposed to the advertising of the sponsor 23 each time that the card 10 is presented for a discount from the vendor 27. The cardholder 25 receives positive reinforcement by obtaining a discount through presentation of the card, thereby causing the cardholder 25 to associate the sponsor 23 with a pleasurable experience. When the cardholder 25 is in need of goods or services similar to those offered by sponsor 23, the positive association and repetitive advertising encourages the selection of sponsor 23 to provide the needed goods or services. The fact that the cardholder may receive discounts through presentation of the promotional card 10 differentiates this business card from others so that a customer is less likely to discard the business card as it entitles the cardholder to potential future savings.

It is therefore to be understood that while a preferred form of invention is herein set forth and described, various modifications and changes may be made therein without departing from the spirit and scope of the present invention as defined by the appended claims and reasonable equivalents thereof.

I claim:

1. A device for advertising including discounts and promotions comprising:
a promotional card including a front face containing identifying business information of a sponsor imprinted thereon and a second face including a record of transactions.

2. A device as defined in claim 1 wherein said card is sized to conform to the dimensions of a standard business card.

3. A device as defined in claim 1 wherein the business information of said sponsor includes a photograph of said sponsor.

4. A device as defined in claim 1 wherein said front face of said card is defined by a business card of said sponsor.

5. A device as defined in claim 4 wherein said front face is laminated to said second face.

6. A device as defined in claim 1 wherein said one of said front face and said second face includes identifying information of a promoter imprinted thereon.

7. A device as defined in claim 1 wherein said front face also contains identifying information of a promoter imprinted thereon.

8. A device as defined in claim 1 wherein said second face includes information governing use of said device by a cardholder.

9. A method of advertising on a promotional card comprising the steps of:
a) placing identifying information of a sponsor on a front face of said promotional card;
b) imprinting on an opposite face of said card a grid relating to promotional transactions; and
c) circulating said promotional card to customers of said sponsor together with information identifying selected vendors.

10. The method according to claim 9 including the step of imprinting identifying information of a promoter on said promotional card.

11. The method according to claim 9 including the step of laminating said promotional card.

12. The method according to claim 11 further including the step of laminating said front face of said promotional card.

13. The method according to claim 9 including the step of advertising said vendors through a publication or website.

14. The method according to claim 9 including the step of presenting said card to said vendor by said customers whereby to redeem said promotional transactions.

15. The method according to claim 14 including the step of recording said redeemed promotional transactions on said grid.

16. In a business card for use by a sponsor to bear business information about the sponsor and wherein the business card contains identification of said sponsor, the improvement comprising:
said card bearing information of a promotional nature to encourage repeated use of said card by a cardholder including spaces to record each promotional transaction in which said card is used.

17. In an improved business card according to claim 16 wherein said promotional transaction consists of discounts offered by vendors.

18. In an improved business card according to claim 17 wherein said cardholder presents said card to said vendors to obtain said discounts.

19. In an improved business card according to claim 16 wherein the business information on said card includes the name and address of said sponsor.

20. In an improved business card according to claim 16 wherein said card includes an identification of a promoter of said card.

21. In an improved business card according to claim 16 wherein said card includes rules imprinted thereon which govern each of said promotional transactions.
